(19) United States
(12) Patent Application Publication
(10) Pub. No.: US 2025/0330390 A1
(43) Pub. Date: Oct. 23, 2025

(54) NETWORK SYSTEM EMPLOYING JOINTLY-TRAINED NEURAL NETWORK PATH FOR SEMANTIC COMMUNICATION

(71) Applicant: GOOGLE LLC, Mountain View, CA (US)

(72) Inventors: Jibing Wang, San Jose, CA (US); Erik Richard Stauffer, Sunnyvale, CA (US)

(21) Appl. No.: 19/180,263

(22) Filed: Apr. 16, 2025

Related U.S. Application Data
(60) Provisional application No. 63/635,071, filed on Apr. 17, 2024.

(51) Int. Cl. H04L 41/16; G06N 3/045; G06N 3/08

(52) U.S. Cl. CPC H04L 41/16; G06N 3/045; G06N 3/08

(57) ABSTRACT

A network component implements a first neural network and a second neural network, and a user equipment implements a third neural network and a fourth neural network. Application data is processed at the first neural network to generate a first signal that represents semantic code representative of at least one semantic meaning of the application data. The first signal is processed at the second neural network to generate a second signal that is a channel encoded representation of the first signal. The second signal is processed at the third neural network to generate a third signal that is a channel decoded representation of the first signal, and the third signal is processed at the fourth neural network to generate an output representing the at least one semantic meaning. The output is processed at the user equipment to control at least one operation of the user equipment.

### BACKGROUND

Conventional communication schemes seek to achieve high or perfect fidelity between the source data transmitted and the destination data received; that is, the destination data is a perfect or near-perfect replication of the data transmitted. To provide this high-fidelity transmission, such communication schemes typically rely on various mechanisms that are often complex and expensive to implement, such as compression/decompression mechanisms, error detection and correction mechanisms, and the like. However, in some instances, it is not the exact form of the data itself, but rather a representation of the substance of the information conveyed by the data that matters. For example, in an image recognition context, it may be more relevant to transmit an indication that an image contains a dog as a subject than to transmit the image of the particular dog itself. As another example, it may be more relevant to transmit a summary or synopsis of an audio recording than the audio data of the audio recording (e.g., the date and time of a doctor's appointment mentioned in a voicemail rather than the audio data of the voicemail itself).

### SUMMARY OF EMBODIMENTS

Example 1: A computer-implemented method in a first device of a network, including receiving, from a second device in the network, a first signal representative of a semantic code, the semantic code representing at least one semantic meaning of application data, processing the first signal by at least a first neural network of the first device to generate a representation of the at least one semantic meaning, and controlling an operation of a software application executing at the first device based on the at least one semantic meaning.

Example 2: The method of Example 1, wherein processing the first signal further includes processing the first signal at a second neural network of the first device to generate a second signal that is a channel decoded representation of the first signal, and processing the second signal at the first neural network to generate the representation of the at least one semantic meaning.

Example 3: The method of Example 2, wherein the first neural network is jointly trained with the second neural network.

Example 4: The method of Example 2, wherein the first neural network and the second neural network are jointly trained with at least a third neural network implemented at the second device.

Example 5: The method of any of Examples 2 to 4, wherein generating the representation of the at least one semantic meaning is further based on processing sensor data from one or more sensors of the first device at the second neural network concurrent with processing the first signal at the second neural network.

Example 6: The method of any of Examples 1 to 5, further including receiving an indication of the first neural network responsive to transmitting situational context information to the second device, the situational context information representing at least one of a present situational context of the first device or a semantic requirement of the software application, and implementing the first neural network at the first device responsive to receiving the indication.

Example 7: The method of Example 6, wherein the situational context information includes at least one of: present capabilities of the first device, an application type of the software application, a semantic communication capability of the software application, a present location of the first device, a network condition of the first device, a processing bandwidth of the first device, a memory bandwidth of the first device, a power status of the first device, or a network condition of a network channel between the first device and the second device.

Example 8: The method of either Example 6 or Example 7, wherein the semantic requirement includes at least one of: a semantic quantization level, a perceptional evaluation of speech quality (PESQ) score requirement, an image similarity metric, or a Fifth Generation quality of service identifier (5QI) requirement.

Example 9: The method of any of Examples 6 to 8, wherein the indication of the first neural network includes at least one of: an identifier of one of a plurality of candidate neural networks accessible by the first device, or data representing a neural network architectural configuration of the first neural network.

Example 10: The method of Examples 1 to 9, wherein the first signal is an output of processing of the application data by a third neural network at the second device that is connected to the first device via a network channel.

Example 11: The method of Example 10, wherein the first neural network is jointly trained with the third neural network.

Example 12: The method of any of Examples 1 to 11, wherein controlling the operation of the software application includes controlling the software application to present the at least one semantic meaning to a user of the first device.

Example 13: The method of any of Examples 1 to 12, wherein at least one of: the application data is an image and the at least one semantic meaning is an identifier of a subject represented in the image, the application data is a video and the at least one semantic meaning is a synopsis or summary of content of the video, the application data is audio data and the at least one semantic meaning is a synopsis or summary of a content of the audio data, or the application data is text and the at least one semantic meaning is a synopsis or summary of a topic of the text.

Example 14: The method of any of Examples 1 to 13, wherein the first device is a user equipment and the second device is a network component of a core network of the network.

Example 15: The method of any of Examples 1 to 13, wherein the first device is a network component of a core network of the network and the second device is a user equipment.

Example 16: A computer-implemented method in a first device of a network, including processing application data by at least a first neural network of the first device to generate a first signal representing a semantic code, the semantic code representing at least one semantic meaning of the application data, and transmitting the first signal for receipt by a second device of the network.

Example 17: The method of Example 16, wherein processing the application data further includes processing the application data at the first neural network to generate a second signal, and processing the second signal at a second neural network of the first device to generate a third signal, the third signal being a channel encoded representation of the second signal.

Example 18: The method of Example 17, wherein the first neural network is jointly trained with the second neural network.

Example 19: The method of Example 17, wherein the first neural network and the second neural network are jointly trained with at least a third neural network implemented at the second device.

Example 20: The method of any of Examples 17 to 19, wherein generating the first signal is further based on processing sensor data from one or more sensors of the first device at the second neural network concurrent with processing the first signal at the second neural network.

Example 21: The method of any of Examples 17 to 20, further including receiving, from the second device, situational context information representing at least one of a present situational context of the second device or a semantic requirement of a software application of the second device, and transmitting an indication of the second neural network to the second device responsive to selecting the first neural network for use at the first device and the second neural network for use at the second device based on the situational context information.

Example 22: The method of Example 21, wherein the situational context information includes at least one of: present capabilities of the second device, an application type of the software application, a semantic communication capability of the software application, a present location of the second device, a network condition of the second device, a processing bandwidth of the second device, a memory bandwidth of the second device, a power status of the second device, or a network condition of a network channel between the first device and the second device.

Example 23: The method of either Example 21 or Example 22, wherein the semantic requirement includes at least one of: a semantic quantization level, a perceptional evaluation of speech quality (PESQ) score requirement, an image similarity metric, or a Fifth Generation quality of service identifier (5QI) requirement.

Example 24: The method of any of Examples 21 to 23, wherein the indication of the second neural network includes at least one of: an identifier of one of a plurality of candidate neural networks accessible by the second device, or data representing a neural network architectural configuration of the second neural network.

Example 25: The method of any of Examples 21 to 24, wherein the first neural network and the second neural network comprise deep neural networks (DNNs).

Example 26: The method of any of Examples 16 to 25, wherein the first device is a user equipment and the second device is a network component of a core network of the network.

Example 27: The method of any of Examples 16 to 25, wherein the first device is a network component of a core network of the network and the second device is a user equipment.

Example 28: A first device including a network interface, at least one processor coupled to the network interface, and a non-transitory computer-readable medium storing a set of instructions, the set of instructions configured to manipulate one or both of the at least one processor or the network interface to perform the method of any of Examples 1 to 27.

Example 29: A method in a cellular system, including configuring a network component to implement a first neural network and a second neural network, and a user equipment to use a third neural network and a fourth neural network based on one or both of a present situational context of the user equipment or semantic requirement of a software application of the user equipment, wherein the first neural network has been jointly trained with at least the fourth neural network, generating, at an application server, application data, processing the application data at the first neural network to generate a first signal, the first signal representing semantic code representative of at least one semantic meaning of the application data, processing the first signal at the second neural network to generate a second signal, the second signal being a channel encoded representation of the first signal, transmitting the second signal from the network component to the user equipment, processing the second signal at the third neural network to generate a third signal, the third signal being a channel decoded representation of the first signal, processing the third signal at the fourth neural network to generate an output, the output representing the at least one semantic meaning, and processing the output at the user equipment to control at least one operation of the user equipment.

Example 30: The method of Example 29, wherein the first neural network is jointly trained with the fourth neural network.

Example 31: The method of Example 29, wherein the second neural network is jointly trained with the third neural network.

Example 32: The method of Example 29, wherein the first neural network is jointly trained with the second neural network, the third neural network, and the fourth neural network.

Example 33: A system including a network component and a user equipment to perform the method of any of Examples 29 to 32.

### BRIEF DESCRIPTION OF THE DRAWINGS

The present disclosure is better understood, and its numerous features and advantages made apparent to those skilled in the art, by referencing the accompanying drawings. The use of the same reference symbols in different drawings indicates similar or identical items.

FIG. 1 is a diagram illustrating an example wireless system employing an end-to-end jointly-trained neural network path with distributed semantic communication in accordance with some embodiments.

FIG. 2 is a diagram illustrating an example configuration of a user equipment (UE) of the wireless system of FIG. 1 in accordance with some embodiments.

FIG. 3 is a diagram illustrating an example configuration of a base station (BS) of the wireless system of FIG. 1 in accordance with some embodiments.

FIG. 4 is a diagram illustrating a machine learning module employing a neural network for use in an end-to-end jointly-trained neural network path with distributed semantic communication in accordance with some embodiments.

FIGS. 5 and 6 together are a ladder diagram illustrating an example method for distributed semantic communication in the wireless system of FIG. 1 in accordance with some embodiments.

FIG. 7 is a flow diagram illustrating an example method for joint training of a candidate set with a semantic encoder neural network, channel encoder neural network, a channel decoder neural network, and a semantic decoder neural network in accordance with some embodiments.

### DETAILED DESCRIPTION

Conventional transmission schemes transmit a replication of the source data, that is, as a lossless or lossy transmission of the bits or symbols composing the source data, using complex and/or expensive mechanisms in support of such high-fidelity transmissions. However, in some instances, accurate transmission of the data is not the goal, but rather a conveyance of the semantics behind the data. Accordingly, in some implementations a wireless system or other network employs a distributed semantic communication scheme in which an end-to-end jointly-trained neural network path exchanges semantic information between an application server (or a component of a core network) and a user equipment (UE), or between the UE and the application server (or a component of the core network). This distributed semantic communication neural network path includes a semantic encoder neural network and a semantic decoder neural network, which have been jointly trained.

The semantic encoder neural network is implemented between the application server and the UE (e.g., at a component of the core network or at the base station serving to wirelessly connect the UE to the rest of the network) and operates to, in effect, identify, extract, or otherwise generate a semantic code from application data received from the application server. This semantic code is a representation of at least one semantic meaning of the application data. The semantic decoder neural network is implemented at the UE and operates, in effect, to decode the semantic code to extract the at least one semantic meaning represented by the semantic code. The extracted semantic meaning(s) then may be supplied in one or more forms to one or more software applications executing at the UE for use in controlling one or more operations of the UE.

Thus, in this approach, rather than transmitting extensive application data from the application server to the UE via a potentially-limited network channel, the network can utilize a jointly-trained neural network pathway to identify and encode the semantic meaning(s) of the application data, transmit representation(s) of the semantic meanings to the UE, and to extract the semantic meaning(s) from the transmitted information at the UE using less complex, less expensive, and/or more efficient mechanisms than conventional high-fidelity data transmission schemes. A user may later follow-up with a request for conventional high-fidelity data transmission.

Further, in some implementations the end-to-end jointly-trained neural network path also includes a channel encoder neural network and channel decoder neural network positioned in the communication path between the semantic encoder neural network and the semantic decoder neural network. These two sets of neural networks (semantic and channel) work together to provide for efficient transmission of the semantic code via the transmission channel connecting the core network to the UE. The channel encoder neural network may be located at, for example, the base station, and operates to, in effect, encode the semantic code output by the semantic encoder neural network to generate an output that is then transmitted to the UE. At the UE, the channel decoder neural network operates to, in effect, decode the transmitted output to generate a decoded output, which is then processed by the semantic decoder neural network to generate an output representing the one or more semantic meanings represented by the original semantic code.

In at least one embodiment, the semantic encoder neural network and the semantic decoder neural network are jointly trained based on, for example, channel conditions, UE capabilities, base station/core network component capabilities, KPI requirements, and the like. Further, in some embodiments, the semantic encoder neural network, the channel encoder neural network, the channel decoder neural network, and the semantic decoder neural network are jointly trained as an end-to-end neural network path.

Different UEs may have different capabilities for implementing a semantic decoder neural network, and these capabilities may change over time due to a changing situational context for the UE (e.g., a changing battery reserve, additional or fewer processor demands, or a change in the current headroom for a thermal limit). Further, the network capabilities may differ between UEs, and also may vary over time for the same UE. Moreover, a software application utilizing the distributed semantic communication scheme may have specific requirements, such as specific semantic key performance indicator (KPI) requirements, and these requirements may dynamically change. Accordingly, in some implementations the system has access to a plurality of candidate neural network paths having different combinations of parameter values for semantic encoder neural networks, semantic decoder neural networks, channel encoder neural networks, and channel decoder neural networks to reflect different implementation circumstances. The UE thus can report its present situational context (including present capabilities and/or present network status) and the applicable semantic KPIs to the network. The network then uses this reported information to select a suitable neural network path from a plurality of candidate neural network paths for implementation in the pathway between the network and the UE. The network can then direct the UE to use the corresponding semantic decoder neural network and channel decoder neural network from the selected neural network path. In the event that circumstances change, such as a change in the present situational context of the UE or a change in the semantic KPIs for the software application, the network can select and implement a new or revised neural network pathway to better accommodate the changed circumstances.

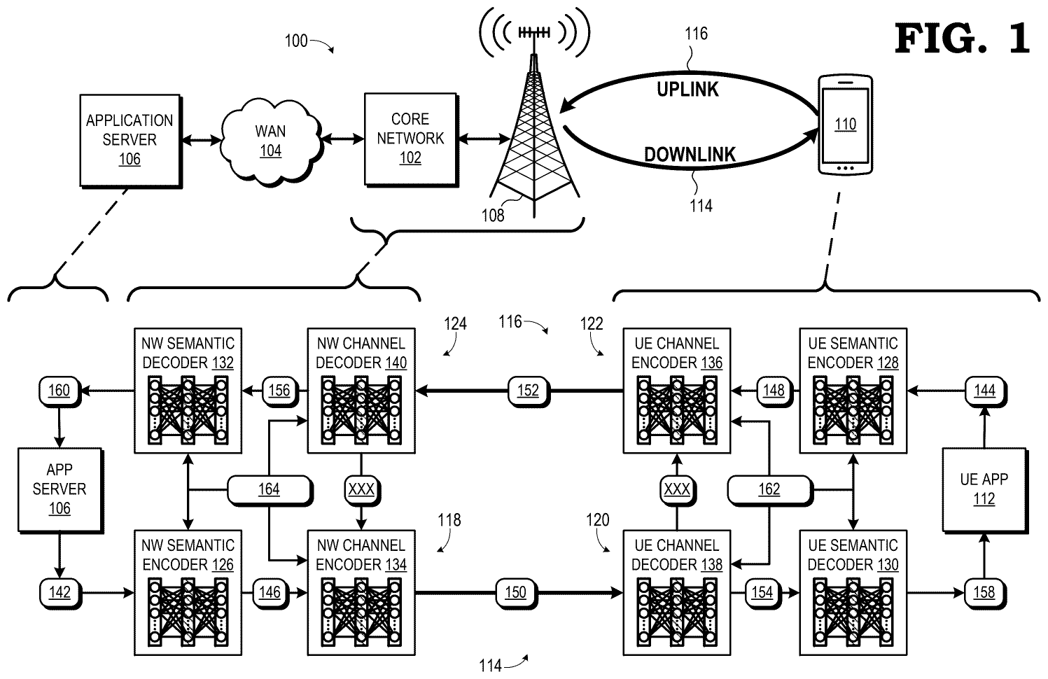

FIG. 1 illustrates downlink (DL) and uplink (UL) operations of an example wireless communications network 100 employing an end-to-end jointly-trained neural network path with distributed semantic communication in accordance with some embodiments. As depicted, the wireless communication network 100 is a cellular network including a core network 102 coupled to one or more wide area networks (WANs) 104 or other packet data networks (PDNs), such as the Internet, and to at least one application server 106. The wireless communication network 100 further includes at least one base station (BS) 108. Each BS 108 supports wireless communication with one or more UEs of the network 100, such as UE 110, via radio frequency (RF) signaling using one or more applicable radio access technologies (RATs) as specified by one or more communications protocols or standards. As such, the BS 108 operates as the wireless interface between the UE 110 and various networks and services provided by the core network 102 and other networks, such as packet-switched (PS) data services, circuit-switched (CS) services, and the like. Conventionally, communication of signaling from the BS 108 to the UE 110 is referred to as “downlink” or “DL” whereas communication of signaling from the UE 110 to the BS 108 is referred to as “uplink” or “UL.”

The BS 108 can employ any of a variety of RATs, such as a BS operating as a NodeB (or base transceiver station (BTS)) for a Universal Mobile Telecommunications System (UMTS) RAT (also known as “3G”), operating as an enhanced NodeB (eNodeB) for a Third Generation Partnership Project (3GPP) Long Term Evolution (LTE) RAT, operating as a 5G node B (“gNB”) for a 3GPP Fifth Generation (5G) New Radio (NR) RAT, and the like. The UE 110, in turn, can implement any of a variety of electronic devices operable to communicate with the BS 108 via a suitable RAT, including, for example, a mobile cellular phone, a cellular-enabled tablet computer or laptop computer, a desktop computer, a cellular-enabled video game system, a server, a cellular-enabled appliance, a cellular-enabled automotive communications system, a cellular-enabled smartwatch or other wearable device, and the like.

In operation, the application server 106 supports one or more services provided by the network 100 to one or more software applications (e.g., software application 112) executed by the UE 110. As such, information in support of these services may be transmitted from the application server 106 to the UE 110 via a downlink pathway 114 between the BS 108 and the UE 110 and/or from the UE 110 to the application server 106 via an uplink pathway 116 between the UE 110 and the BS 108. Note that reference to “source device” thus refers to the BS 108 for the downlink pathway 114 and to the UE 110 for the uplink pathway 116, whereas reference to “destination device” refers to the UE 110 for the downlink pathway 114 and to the BS 108 for the uplink pathway 116.

In a conventional data communication scheme, the downlink information (that is, information transmitted via the downlink pathway 114) would be a high-fidelity representation of application (user plane) data output by the application server 106 and the uplink information (that is, information transmitted via the uplink pathway 116) would be a high-fidelity representation of application (user plane) data output by the one or more software applications 112 executing at the UE 110. However, in some implementations, it is not necessary, intended, desirable, and/or possible to transmit a high-fidelity representation of the application data itself from the source to the destination via the corresponding one of the pathways 114, 116. For example, in some implementations, limitations in the wireless channel between the UE 110 and the BS 108 may make high-fidelity transmission of application data impracticable, even in compressed form. As another example, one or both of the BS 108 or the UE 110 may lack the capabilities to sufficiently process the application data in its high-fidelity form. As yet another example, in some implementations the destination consumer of the application data (that is, the software application 112 at the UE 110 for downlink, the application server 106 for uplink) may not need the application data in its full form or even be configured to handle processing of the application data in its full form, but instead may be configured to operate on the basis of one or more sematic meanings that may be extracted from the application data. For example, the application data may be video data and the software application 112 executing at the UE 110 may not need access to the video data itself, but rather an indication of objects identified in the scene represented in the video data. As another example, the application data may be audio data captured by the UE 110, and rather than receiving a copy of the audio data from the UE 110, the application server 106 instead may be configured to request a synopsis of the content of the audio data from the UE 110. Accordingly, rather than (or in addition to) implementing a conventional high-fidelity data transmission scheme, the network 100 employs a distributed semantic communication path for one or both of the downlink pathway 114 or the uplink pathway 116 that utilizes an end-to-end jointly-trained neural network path.

Accordingly, in some embodiments both the BS 108 and the UE 110 implement transmitter (TX) and receiver (RX) processing paths that integrate one or more neural networks (NNs) that are trained or otherwise configured to support distributed semantic communication of semantic meanings in generated application (user plane) data. To illustrate, for the downlink pathway 114, the BS 108 employs a downlink (DL) TX processing path 118 and the UE 110 employs a DL RX processing path 120 in support of semantic-based downlink transmissions. Likewise, for the uplink pathway 116, the UE 110 can employ an uplink (UL) TX processing path 122 and the BS 108 can employ an UL RX processing path 124. Each TX processing path 122, 124 includes a corresponding semantic encoder neural network, including a network (NW) semantic encoder neural network 126 for the TX processing path 118 and a UE semantic encoder neural network 128 for the TX processing path 122. Each RX processing path 120, 124 includes a corresponding semantic decoder neural network, including a UE semantic decoder neural network 130 for RX processing path 120 and a network semantic decoder neural network 132 for RX processing path 124.

Further, in some implementations, one or both of the TX processing paths 118, 122 employs a corresponding channel encoder neural network, such as a network channel encoder neural network 134 for the network TX processing path 118 and a UE channel encoder neural network 136 for the UE TX processing path 122. In such instances, one or both of the RX processing path 120, 124 can employ a corresponding channel decoder neural network, such as UE channel decoder neural network 138 for the UE RX processing path 120 and a network channel decoder neural network 140 for the network RX processing path 124. Moreover, in some instances, one of the channel encoder neural network or the channel decoder neural network may be absent. For example, an instance of the UE 110 may lack the processing capacity to implement the UE channel decoder neural network 138 and thus refrain from its implementation. As described below, the architectures of the remaining neural networks in the pathway can be jointly trained so as to accommodate the absence of one of these channel neural networks.

Each of the semantic encoder neural networks 126 and 128 and each of the semantic decoder neural networks 130 and 132 includes one or more neural networks, such as a deep neural network (DNN), convolutional neural network (CNN), recurrent neural network (RNN), and the like. Likewise, when implemented in the network 100, each of the channel encoder neural networks 134 and 136 and each of the channel decoder neural networks 138 and 140 includes one or more neural networks, and may be the same or different type(s) of neural networks as the semantic encoder/decoder neural networks.

In embodiments, the network semantic encoder neural network 126 and the UE semantic decoder neural network 130 are “paired” for use in performing semantic encoding and decoding operations for the downlink pathway 114, and the UE semantic encoder neural network 128 and the network semantic decoder neural network 132 are “paired” for use in performing semantic encoding and decoding operations for the uplink pathway 116. To this end, each semantic encoder neural network operates to receive, as an input, application data, such as application data 142 from the application server 106 for the network semantic encoder neural network 126 or application data 144 from the software application 112 for the UE semantic encoder neural network 128). The semantic encoder neural network further may receive additional inputs, such as situational context data for the source device, destination device, or the network channel connecting the two (e.g., situational context data 162 for the UE 110 or situational context data 164 for the BS 108), and the like. The semantic encoder neural network then processes these one or more inputs based on its trained configuration to generate a first output signal (e.g., first output signal 146 for the semantic encoder neural network 126 or first output signal 148 for the semantic encoder neural network 128) representing a semantic code, the semantic code itself representing one or more semantic meanings for the input application data.

For example, depending on the training and resulting trained configuration, the application data could represent an image or video (that is, a series of images) and a semantic meaning for the image or video as represented by the resulting semantic code could include an identifier of an object or subject of the image/video, an identifier of one or more qualities or characteristics of such object or subject, confirmation of the presence or absence of such object or subject in the image/video, and the like. As another example, the application (user plane) data could be audio data, and a semantic meaning for the audio data could include a summary or synopsis of the subject or audio content of the audio data, an identifier of one or more qualities or characteristics of such object or subject, confirmation of the presence or absence of such object or subject in the audio data, and the like. As yet another example, the application (user plane) data could be text data, a semantic meaning for the text data could include a summary or synopsis of the subject or text content of the text data, an identifier of one or more qualities or characteristics of such object or subject, confirmation of the presence or absence of such object or subject in the text data, and the like.

In embodiments, the network channel encoder neural network 134 and the UE channel decoder neural network 138 are “paired” for use in performing channel encoding and decoding operations for the downlink pathway 114, and the UE channel encoder neural network 136 and the network channel decoder neural network 140 are “paired” for use in performing channel encoding and decoding operations for the uplink pathway 116. Thus, in implementations in which a channel encoder/decoder neural network pair is implemented in the transmission path, the first output signal is provided as an input to the corresponding channel encoder neural network, which operates to process the first output signal along with any other inputs (e.g., local sensor data, data representing current conditions for the wireless channel connecting the BS 108 and the UE 110, etc.), to generate a second output signal representing a channel encoded representation of the first output signal, such as second output signal 150 generated by the network channel encoder neural network 134 from the first output signal 146 or the second output signal 152 generated by the UE channel encoder neural network 136 from the first output signal 148. Thus, the corresponding channel encoder neural network operates in accordance with its trained architectural configuration to, in effect, channel encode the received first output signal based on current channel conditions and the current situational context of the source device and/or destination device. This second output signal is then transmitted to the destination device via the wireless channel. At the destination device, the corresponding channel decoder neural network receives the second output signal (or transmitted representation thereof) as an input, and processes this input along with other inputs (such as local sensor data) to generate a third output signal representing a channel-decoded representation of the corresponding first input signal (that is, recovery of a representation of the corresponding second input signal), such as the UE channel decoder neural network 138 generating a third output signal 154 from the received representation of the second output signal 150 or the network channel decoder neural network 140 generating a third output signal 156 from the received representation of the second output signal 152, with the third output signal 154 comprising a recovered representation of the first output signal 146 and the third output signal 156 representing a recovered representation of the first output signal 148.

In implementations in which a channel encoder/decoder neural network pair is not employed in the corresponding transmission path, the corresponding first output signal is transmitted from the source device to the destination device in the transmission path using a conventional channel encoding/decoding scheme, with the recovered signal at the destination device following conventional channel decoding standing in for the aforementioned third output signal in the following discussion.

The generated/recovered third output signal then is provided as an input to the corresponding semantic decoder neural network, which operates according to its trained architectural configuration to generate a corresponding fourth output signal that represents the one or more semantic meanings for the corresponding application data as originally determined by the corresponding semantic encoder neural network as reflected in the corresponding output first signal. The receiving device then initiates, terminates, modifies, or otherwise performs one or more operations based on the one or more semantic meanings represented in the fourth output. Thus, for the downlink pathway 114 the UE semantic decoder neural network 130 operates to generate a fourth output signal 158 that represents the one or more semantic meanings determined by the network semantic encoder neural network 126 for the application data 142 and represented in the first output signal 146, and the software application 112 performs one or more operations based on these one or more semantic meanings. Similarly, for the uplink pathway 116, the network semantic decoder neural network 132 operates to generate a fourth output signal 160 that represents the one or more semantic meanings determined by the UE semantic encoder neural network 128 for the application data 144 and as represented by the first output signal 148, and the application server 106 performs one or more operations based on these one or more semantic meanings.

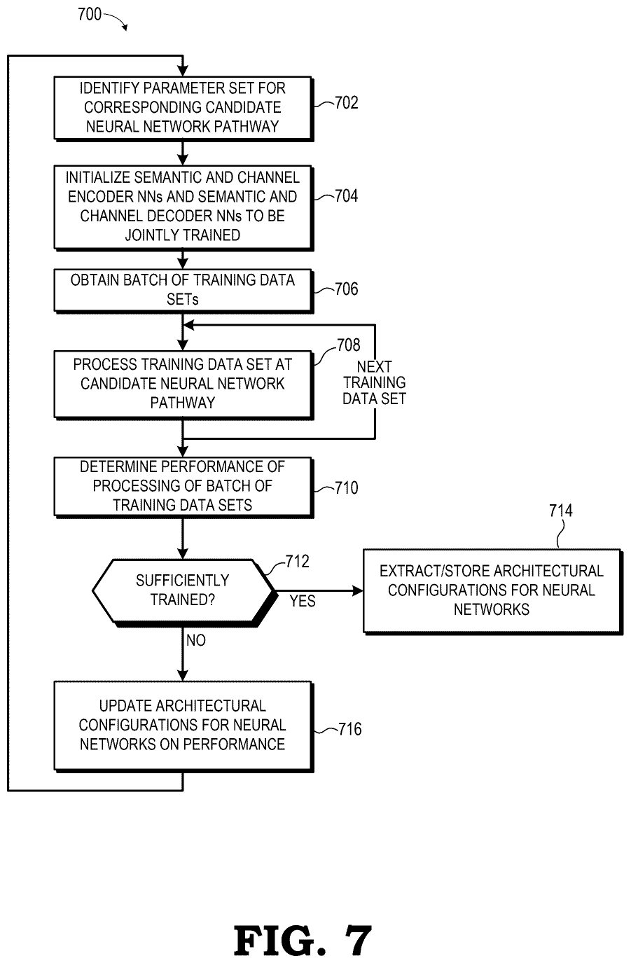

In at least one embodiment, each paired set of semantic encoder neural network and semantic decoder neural network is jointly trained to provide end-to-end distributed semantic communication between the corresponding source device and destination device. Likewise, when employed, each paired set of channel encoder neural network and channel decoder neural network is jointly trained to provide end-to-end channel encoding/decoding between the corresponding source device and destination device. Further, in some embodiments, the semantic encoder neural network, the channel encoder neural network, the channel decoder neural network, and the semantic decoder neural network in a transmission path are jointly-trained to provide end-to-end distributed semantic communication and channel encoding/decoding between the corresponding source device and destination device. This joint training is described in greater detail below with reference to FIG. 7. Moreover, as described in greater detail below, multiple candidate sets of jointly-trained semantic encoder/decoder neural networks and channel encoder/decoder neural networks may be generated or otherwise obtained based on training under different conditions, such as different channel conditions or different contexts for one or both of the source device or the destination device, and a suitable set is selected from the plurality of candidate sets for implementation based on a match or other comparison of the current channel conditions and/or context of the source/destination device with corresponding parameters for each candidate set. Further, in some cases conditions may dynamically change, and a different candidate set of jointly-trained neural networks may be selected and implemented dynamically in response to changing conditions. For example, the semantic quality requirements may dynamically increase or decrease, and a new candidate set of neural network architectural configurations may be selected for implementation based on the changed semantic quality requirements.

Note that while FIG. 1 illustrates an implementation in which each pathway 114, 116 includes a joint pair of semantic encoder/decoder neural networks and joint pair of channel encoder/decoder neural networks, in other implementations one or more of these neural networks may be missing from the pathway. For example, due to processing capacity, memory capacity, or power capacity, the UE 110 may refrain from implementing the UE channel decoder neural network 138, while the BS 108 continues to employ the network channel encoder neural network 134. To accommodate for such instances, in at least one embodiment the network 100 employs different candidate sets of neural network architectural configurations that have been jointly-trained for such situations. For example, the network 100 may have a plurality of candidate sets that have been trained to accommodate the absence of the UE channel decoder neural network 138, such as, for example, by training the UE semantic decoder neural network 130 to implement some of the decoding operations to sufficiently process an input signal that has been generated from the operations of both the network semantic encoder neural network 126 and the network channel encoder neural network 134. As such, one or both of the UE 110 or the BS 108 may activate or deactivate a corresponding channel encoder/decoder neural network as warranted by the current situational context and the network 100 can respond by dynamically selecting and implementing a different candidate set of neural network architectural configurations for the remaining neural networks in the pathway that have been jointly trained so as to accommodate for the absent neural network in the pathway.

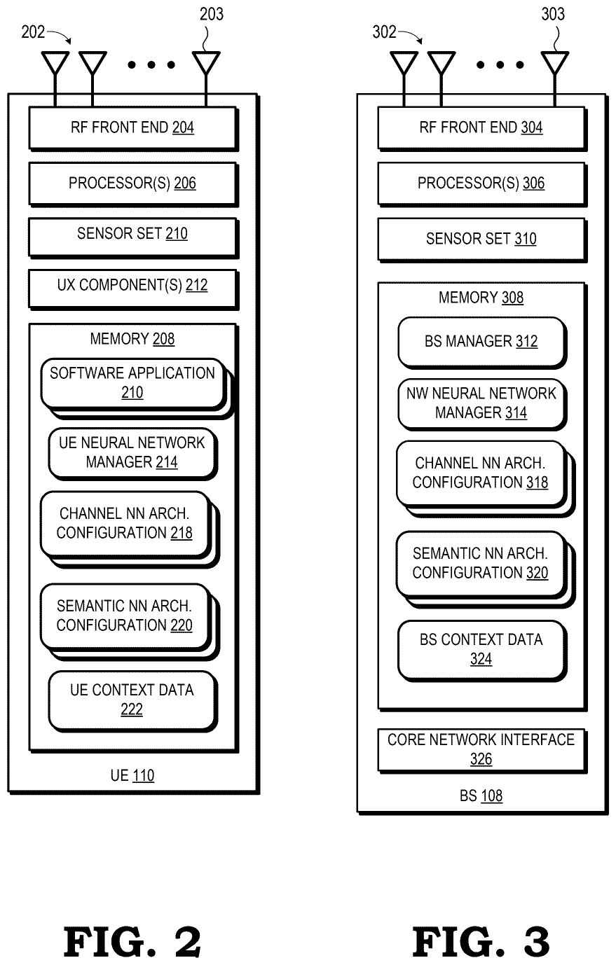

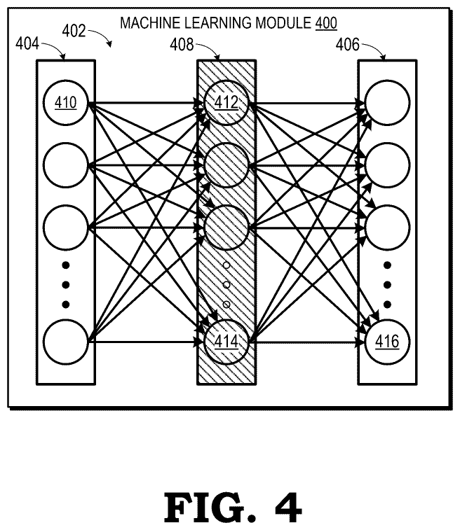

FIGS. 2 and 3 illustrate example hardware configurations for the UE 110 (FIG. 2) and BS 108 (FIG. 3) in accordance with some embodiments. Note that the depicted hardware configurations represent the processing components and communication components most directly related to the neural network-based distributed semantic communication processes described herein and omit certain components well-understood to be frequently implemented in such electronic devices, such as displays, non-sensor peripherals, power supplies, and the like.

Turning to FIG. 2, in the depicted configuration the UE 110 includes one or more antenna arrays 202, with each antenna array 202 having one or more antennas 203, and further includes at least one radio frequency (RF) front end 204, one or more processors 206, and one or more non-transitory computer-readable media 208. The RF front end 204 operates, in effect, as a physical (PHY) transceiver interface to conduct and process signaling between the one or more processors 206 and the one or more antenna arrays 202 so as to facilitate various types of wireless communication. The antennas 203 can include an array of multiple antennas that are configured similar to or different from each other and can be tuned to one or more frequency bands associated with a corresponding radio access technology (RAT). The one or more processors 206 can include, for example, one or more central processing units (CPUs), graphics processing units (GPUs), an artificial intelligence (AI) accelerator or other application-specific integrated circuits (ASIC), and the like. To illustrate, the processors 206 can include an application processor (AP) utilized by the UE 110 to execute an operating system and various user-level software applications 112, as well as one or more processors utilized by modems or a baseband processor of the RF front end 204. The computer-readable media 208 can include any of a variety of media used by electronic devices to store data and/or executable instructions, such as random-access memory (RAM), read-only memory (ROM), caches, Flash memory, solid-state drive (SSD) or other mass-storage devices, and the like. For case of illustration and brevity, the computer-readable media 208 is referred to herein as “memory 208” in view of frequent use of system memory or other memory to store data and instructions for execution by the processor 206, but it will be understood that reference to “memory 208” shall apply equally to other types of storage media unless otherwise noted.

In at least one embodiment, the UE 110 further includes a plurality of sensors, referred to herein as sensor set 210, at least some of which are utilized in the neural-network-based sensor-and-transceiver fusion schemes described herein. Generally, the sensors of sensor set 210 include those sensors that sense some aspect of the environment of the UE 110 or the use of the UE 110 by the user which have the potential to sense a parameter that has at least some impact on, or reflects, an RF propagation path of, or RF transmission/reception performance by, the UE 110 relative to the BS 108. The sensors of sensor set 210 can include one or more sensors for object detection, such as radar sensors, lidar sensors, imaging sensors, structured-light-based depth sensors, and the like. The sensor set 210 also can include one or more sensors for determining a position or pose of the UE 110, such as satellite positioning sensors such as GPS sensors, Global Navigation Satellite System (GNSS) sensors, internal measurement unit (IMU) sensors, visual odometry sensors, gyroscopes, tilt sensors or other inclinometers, ultrawideband (UWB)-based sensors, and the like. Other examples of types of sensors of sensor set 210 can include imaging sensors, such as cameras for image capture by a user, cameras for facial detection, cameras for stereoscopy or visual odometry, light sensors for detection of objects in proximity to a feature of the UE 110, and the like. The UE 110 further may include one or more user experience (UX) components 212 for facilitating a user's interactions with the UE 110, such as one or more keyboards or other user input devices, one or more displays, one or more speakers, one or more haptic devices, and the like.

The one or more memories 208 of the UE 110 are used to store one or more sets of executable software instructions and associated data that manipulate the one or more processors 206 and other components of the UE 110 to perform the various functions described herein and attributed to the UE 110. The sets of executable software instructions include, for example, an operating system (OS), various drivers (not shown) and various user-level software applications, such as the software application 112. The sets of executable instructions further may include a UE neural network manager 214 for implementing the one or more neural networks for the UE 110, such as for implementing and managing one or both of the UE channel encoder neural network 136 or the UE channel decoder neural network 138 and/or one or both of the UE semantic encoder neural network 128 or the UE semantic decoder neural network 130.

The UE neural network manager 214 may have local or remote access to one or more sets of channel neural network architectural configurations 218 that can be used to configure the one or more neural networks employed or managed by the UE neural network manager 214. Further, the UE neural network manager 214 may have local or remote access to one or more sets of semantic neural network architectural configurations 220 that can be used to configure the one or more neural networks employed or managed by the UE neural network manager 214. The one or more neural network architecture configurations 218, 220 include one or more data structures containing data and other information representative of a corresponding architecture and/or parameter configurations used by the corresponding neural network manager to form a corresponding neural network of the UE 110. The information included in a neural network architectural configuration includes, for example, parameters that specify a fully connected layer neural network architecture, a convolutional layer neural network architecture, a recurrent neural network layer, a number of connected hidden neural network layers, an input layer architecture, an output layer architecture, a number of nodes utilized by the neural network, coefficients (e.g., weights and biases) utilized by the neural network, kernel parameters, a number of filters utilized by the neural network, strides/pooling configurations utilized by the neural network, an activation function of each neural network layer, interconnections between neural network layers, neural network layers to skip, and so forth. Accordingly, the neural network architecture configurations 218 and 220 include any combination of neural network formation configuration elements (e.g., architecture and/or parameter configurations) that can be used to create a neural network formation configuration (e.g., a combination of one or more neural network formation configuration elements) that defines and/or forms a DNN or other neural network.

The memory 208 further may store UE context data 222 that includes one or more sets of data that represent the current situational context of the UE 110, including data representing present capabilities of the UE 110, such as processing capabilities, memory capabilities, protocol capabilities, power capabilities, network capabilities, sensor capabilities, semantic communication capabilities, and the like. Such capabilities may be represented as, for example, present minimum capabilities, such as present minimum processing capabilities, present minimum memory capabilities, present minimum protocol capabilities, present minimum power capabilities, and the like. Processing capabilities can include, for example, types and numbers of processors, available processing bandwidth, and the like. Memory capabilities may include, for example, memory bandwidth, memory storage capacity, memory types, or the like. Network capabilities may include, for example, network throughput, network latency, network quality (e.g., signal strength, signal-to-noise ratio, or a similar parameter), dropped packet rate, services supported by the wireless connection, etc. Power capabilities may include, for example, the type of power source currently powering the UE 110 (e.g., battery power vs. wall-outlet power), remaining battery capacity, etc. The protocol capabilities may include an indication of various protocols supported by the UE 110, including cellular protocols or other networking protocols, semantic communication protocols, and the like. Sensor capabilities may include, for example, indication of sensors available for use, their relevant specifications, and the like. Semantic communication capabilities may include, for example, the types of semantic communication supported by the UE 110, such as text synopsis semantics, object identification semantics, etc.

Semantic communication capabilities further may include an indication of the minimum semantic quality or maximum semantic quality supported by the UE 110, as indicated by, for example, any of a variety of semantic quality scores or KPIs. Such semantic quality scores can include, for example, a semantic quantization level (e.g., the degree of summarization, the degree of abstraction, etc.); a perceptional evaluation of speech quality (PESQ) score requirement; an image similarity metric; or a Fifth Generation quality of service identifier (5QI) requirement.

Turning now to FIG. 3, the hardware configuration of the BS 108 is described in accordance with embodiments. It is noted that although the illustrated diagram represents an implementation of the BS 108 as a single network node (e.g., a 5G NR Node B, or “gNB”), the functionality, and thus the hardware components, of the BS 108 instead may be distributed across multiple network nodes or devices and may be distributed in a manner to perform the functions described herein. Moreover, although certain functionality with regard to distributed semantic communication is described herein with reference to the BS 108, it is noted that some or all of this functionality, as well as the corresponding hardware supporting such functionality, may instead be implemented and performed at a different component of the network 100. Thus, reference to the BS 108 also includes reference to such other components unless otherwise noted.

As with the UE 110, the BS 108 includes at least one array 302 of one or more antennas 303, an RF front end 304, as well as one or more processors 306 and one or more non-transitory computer-readable storage media 308 (as with the memory 208 of the UE 110, the computer-readable medium 308 is referred to herein as a “memory 308” for brevity). The BS 108 further includes a sensor set 310 having one or more sensors that provide sensor data that may be used for the distributed semantic communication schemes described herein. As with the sensor set 210 of the UE 110, the sensor set 310 of the BS 108 can include, for example, object-detection sensors, imaging sensors, network sensors, and the like. These components operate in a similar manner as described above with reference to corresponding components of the UE 110.

The one or more memories 308 of the BS 108 store one or more sets of executable software instructions and associated data that manipulate the one or more processors 306 and other components of the BS 108 to perform the various functions described herein and attributed to the BS 108. The sets of executable software instructions include, for example, an OS and various drivers (not shown), various software applications (not shown), and a BS manager 312. The one or more sets of executable software instructions further may implement a network neural network manager 314 for implementing and managing one or both of the network channel encoder neural network 134 or the network channel decoder neural network 140 and/or for implementing and managing one or both of the network semantic encoder neural network 126 or the networks semantic decoder neural network 132.

The network neural network manager 314 may have local or remote access to one or more sets of channel neural network architectural configurations 318 that can be used to configure the one or more neural networks employed or managed by the network neural network manager 314. Likewise, the network neural network manager 314 also may have local or remote access to one or more sets of semantic neural network architectural configurations 320 that can be used to configure the one or more neural networks employed or managed by the network neural network manager 314. The one or more neural network architecture configurations include one or more data structures containing data and other information representative of a corresponding architecture and/or parameter configurations used by the corresponding neural network manager to form a corresponding neural network of the BS 108. The information included in a neural network architectural configuration includes, for example, parameters that specify a fully connected layer neural network architecture, a convolutional layer neural network architecture, a recurrent neural network layer, a number of connected hidden neural network layers, an input layer architecture, an output layer architecture, a number of nodes utilized by the neural network, coefficients (e.g., weights and biases) utilized by the neural network, kernel parameters, a number of filters utilized by the neural network, strides/pooling configurations utilized by the neural network, an activation function of each neural network layer, interconnections between neural network layers, neural network layers to skip, and so forth. Accordingly, the neural network architecture configurations 318 and 320 include any combination of neural network formation configuration elements (e.g., architecture and/or parameter configurations) that can be used to create a neural network formation configuration (e.g., a combination of one or more neural network formation configuration elements) that defines and/or forms a DNN or other neural network.

The memory 308 further may store BS context data 324 that includes one or more sets of data that represent the current situational context of the BS 108, including data representing present capabilities of the BS 108, such as processing capabilities, memory capabilities, protocol capabilities, power capabilities, network capabilities, sensor capabilities, the number of UEs currently being supported, and the like. The BS manager 312 operates to control and configure the operation of the neural networks of the downlink pathway 114 and the uplink pathway 116. Such operations can include receiving or otherwise determining a current situational context of the UE 110 as relevant to the ability of the UE 110 to operate one or more neural networks, determining a current situational context of the BS 108 as relevant to the ability of the BS 108 to operate one or more neural networks, selecting sets of neural network architectural configurations for implementation at one or both of the UE 110 or the BS 108 based on these determined current situational contexts, and the like. The BS 108 further can include a core network interface 326 that the BS manager 312 configures to exchange user-plane, control-plane, and other information with core network functions and/or entities.

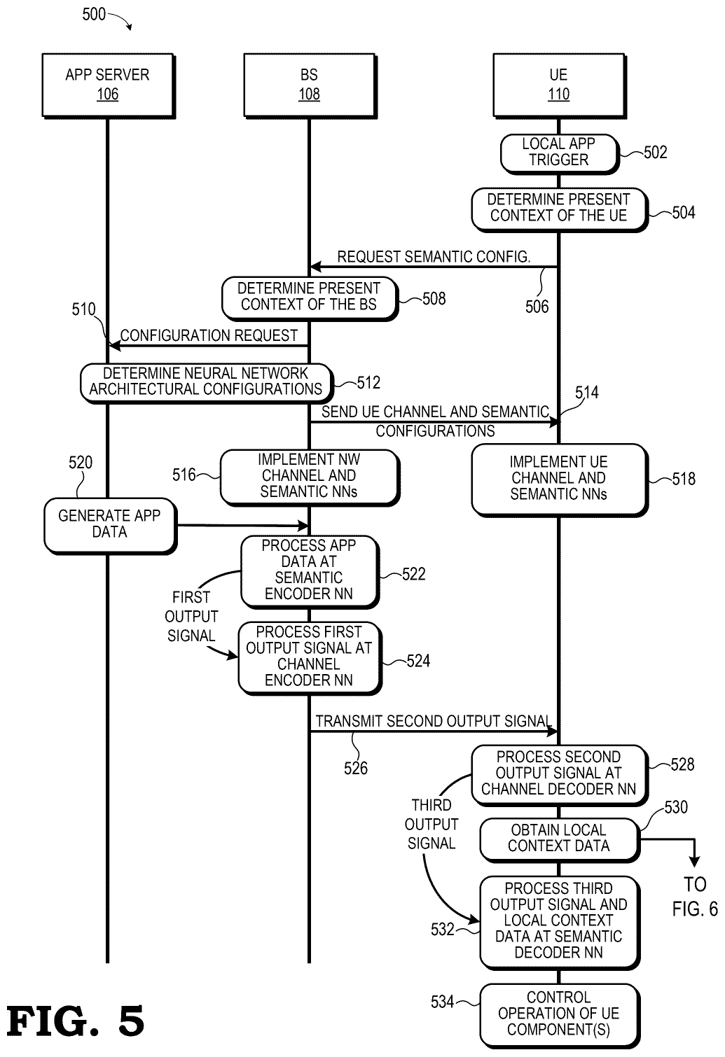

FIG. 4 illustrates an example machine learning (ML) module 400 for implementing a neural network in accordance with some embodiments. As described herein, one or both of the BS 108 and the UE 110 implement one or more neural networks in the downlink pathway 114 or the uplink pathway 116. The ML module 400 therefore illustrates an example module for implementing one or more of these neural networks. For example, the ML module 400 may represent a DNN implemented as one of the neural networks 126, 128, 130, 132, 134, 136, 138, or 140 of FIG. 1.

In the depicted example, the ML module 400 implements at least one deep neural network (DNN) 402 with groups of connected nodes (e.g., neurons and/or perceptrons) that are organized into three or more layers. The nodes between layers are configurable in a variety of ways, such as a partially-connected configuration where a first subset of nodes in a first layer are connected with a second subset of nodes in a second layer, a fully-connected configuration where each node in a first layer is connected to each node in a second layer, etc. A neuron processes input data to produce a continuous output value, such as any real number between 0 and 1. In some cases, the output value indicates how close the input data is to a desired category. A perceptron performs linear classifications on the input data, such as a binary classification. The nodes, whether neurons or perceptrons, can use a variety of algorithms to generate output information based upon adaptive learning. Using the DNN 402, the ML module 400 performs a variety of different types of analysis, including single linear regression, multiple linear regression, logistic regression, step-wise regression, binary classification, multiclass classification, multivariate adaptive regression splines, locally estimated scatterplot smoothing, and so forth.

In some implementations, the ML module 400 adaptively learns based on supervised learning. In supervised learning, the ML module 400 receives various types of input data as training data. The ML module 400 processes the training data to learn how to map the input to a desired output. During a training procedure, the ML module 400 uses labeled or known data as an input to the DNN 402. The DNN 402 analyzes the input using the nodes and generates a corresponding output. The ML module 400 compares the corresponding output to truth data and adapts the algorithms implemented by the nodes to improve the accuracy of the output data. Afterward, the DNN 402 applies the adapted algorithms to unlabeled input data to generate corresponding output data. The ML module 400 uses one or both of statistical analyses and adaptive learning to map an input to an output. For instance, the ML module 400 uses characteristics learned from training data to correlate an unknown input to an output that is statistically likely within a threshold range or value. This allows the ML module 400 to receive complex input and identify a corresponding output. Some implementations train the ML module 400 on characteristics of communications transmitted over a wireless communication system (e.g., time/frequency interleaving, time/frequency deinterleaving, convolutional encoding, convolutional decoding, power levels, channel equalization, inter-symbol interference, quadrature amplitude modulation/demodulation, frequency-division multiplexing/de-multiplexing, transmission channel characteristics). This allows the trained ML module 400 to receive samples of a signal as an input, such as samples of a downlink signal received at a UE, and recover information from the downlink signal, such as the binary data embedded in the downlink signal.

In the depicted example, the DNN 402 includes an input layer 404, an output layer 406, and one or more hidden layers 408 positioned between the input layer 404 and the output layer 406. Each layer has an arbitrary number of nodes, where the number of nodes between layers can be the same or different. That is, the input layer 404 can have the same number and/or a different number of nodes as output layer 406, the output layer 406 can have the same number and/or a different number of nodes than the one or more hidden layer 408, and so forth.

Node 410 corresponds to one of several nodes included in input layer 404, wherein the nodes perform separate, independent computations. As further described, a node receives input data and processes the input data using one or more algorithms to produce output data. Typically, the algorithms include weights and/or coefficients that change based on adaptive learning. Thus, the weights and/or coefficients reflect information learned by the neural network. Each node can, in some cases, determine whether to pass the processed input data to one or more next nodes. To illustrate, after processing input data, node 410 can determine whether to pass the processed input data to one or both of node 412 and node 414 of hidden layer 408. Alternatively or additionally, node 410 passes the processed input data to nodes based upon a layer connection architecture. This process can repeat throughout multiple layers until the DNN 402 generates an output using the nodes (e.g., node 416) of output layer 406.

A neural network can also employ a variety of architectures that determine what nodes within the neural network are connected, how data is advanced and/or retained in the neural network, what weights and coefficients are used to process the input data, how the data is processed, and so forth. These various factors collectively describe a neural network architecture configuration, such as the neural network architecture configurations 218, 220, 318, and 320 briefly described above. To illustrate, a recurrent neural network, such as a long short-term memory (LSTM) neural network, forms cycles between node connections to retain information from a previous portion of an input data sequence. The recurrent neural network then uses the retained information for a subsequent portion of the input data sequence. As another example, a feed-forward neural network passes information to forward connections without forming cycles to retain information. While described in the context of node connections, it is to be appreciated that a neural network architecture configuration can include a variety of parameter configurations that influence how the DNN 402 or other neural network processes input data.

A neural network architecture configuration of a neural network can be characterized by various architecture and/or parameter configurations. To illustrate, consider an example in which the DNN 402 implements a convolutional neural network (CNN). Generally, a convolutional neural network corresponds to a type of DNN in which the layers process data using convolutional operations to filter the input data. Accordingly, the CNN architecture configuration can be characterized by, for example, pooling parameter(s), kernel parameter(s), weights, and/or layer parameter(s).

A pooling parameter corresponds to a parameter that specifies pooling layers within the convolutional neural network that reduce the dimensions of the input data. To illustrate, a pooling layer can combine the output of nodes at a first layer into a node input at a second layer. Alternatively or additionally, the pooling parameter specifies how and where in the layers of data processing the neural network pools data. A pooling parameter that indicates “max pooling,” for instance, configures the neural network to pool by selecting a maximum value from the grouping of data generated by the nodes of a first layer, and uses the maximum value as the input into the single node of a second layer. A pooling parameter that indicates “average pooling” configures the neural network to generate an average value from the grouping of data generated by the nodes of the first layer and use the average value as the input to the single node of the second layer.

A kernel parameter indicates a filter size (e.g., a width and a height) to use in processing input data. Alternatively or additionally, the kernel parameter specifies a type of kernel method used in filtering and processing the input data. A support vector machine, for instance, corresponds to a kernel method that uses regression analysis to identify and/or classify data. Other types of kernel methods include Gaussian processes, canonical correlation analysis, spectral clustering methods, and so forth. Accordingly, the kernel parameter can indicate a filter size and/or a type of kernel method to apply in the neural network. Weight parameters specify weights and biases used by the algorithms within the nodes to classify input data. In some implementations, the weights and biases are learned parameter configurations, such as parameter configurations generated from training data.

A layer parameter specifies layer connections and/or layer types, such as a fully-connected layer type that indicates to connect every node in a first layer (e.g., output layer 406) to every node in a second layer (e.g., hidden layer 408), a partially-connected layer type that indicates which nodes in the first layer to disconnect from the second layer, an activation layer type that indicates which filters and/or layers to activate within the neural network, and so forth. Alternatively or additionally, the layer parameter specifies types of node layers, such as a normalization layer type, a convolutional layer type, a pooling layer type, and the like.

While described in the context of pooling parameters, kernel parameters, weight parameters, and layer parameters, it will be appreciated that other parameter configurations can be used to form a DNN consistent with the guidelines provided herein. Accordingly, a neural network architecture configuration can include any suitable type of configuration parameter that can be applied to a DNN that influences how the DNN processes input data to generate output data.

In some embodiments, the configuration of the ML module 400 is based on a present situational context of the UE 110, the BS 108, or both, as well as requirements or other parameters of one or more software applications 112 of the UE 110 that utilize the distributed semantic communication scheme, such as semantic KPIs or other indicators of semantic quality or efficiency. To illustrate, consider two jointly-trained instances of the ML module 400; one trained to efficiently extract and compress or otherwise encode semantic meanings from input application information for wireless transmission as an output signal and the other trained to efficiently decompress or otherwise decode encoded semantic meaning information from the output signal for input to the corresponding software application 112 or application server 106 (hereinafter, the “consumer component” of the semantic meaning information). The manner in which the consumer component is to utilize the semantic meaning information, as well as the indicated quality of such information (e.g., semantic KPI) may inform the training of the two paired instances of the ML module 400. For example, when the consumer module is expecting a confirmation of the presence or absence of a particular object within an image (as the subject application data), the paired ML modules 400 may be trained in view of meeting an indicated false positive or false negative accuracy for the semantic meaning extraction and communication process (e.g., 90% accuracy for both parameters). As another example, when the consumer module is expecting as input an image that has a lower complexity compared to an original input image (as the subject application data) while still representing the primary features of the original input image as measured by, for example, a specified structural similarity index measure (SSIM) value, the paired ML modules 400 may be trained in view of meeting this specified SSIM value for input images.

Accordingly, in some embodiments, the device implementing the ML module 400 generates and stores different neural network architecture configurations for different potential situational contexts, such as different combinations of network conditions, available resource configurations, QoS/QoE requirements, semantic quality requirements, software application types, and the like. To this end, paired instances of the ML module 400 can be trained for each combination of interest, and the training may occur offline when no active communication exchanges are occurring, or online during active communication exchanges. The training of such paired instances of the ML module 400 is described in great detail below with reference to FIG. 7.

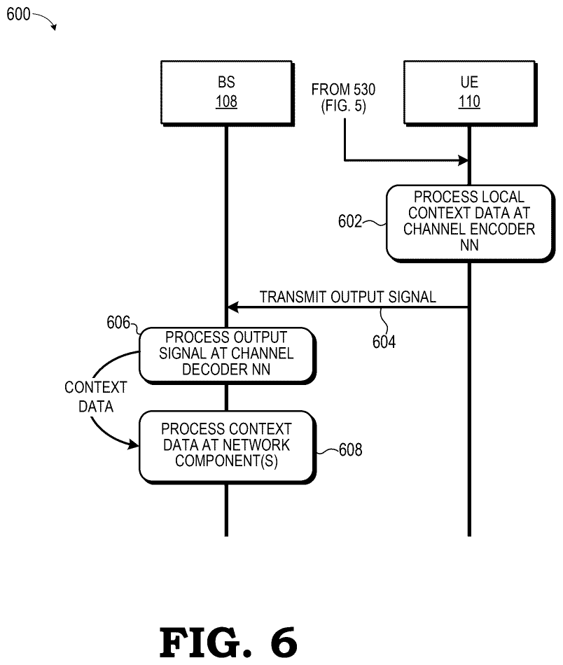

FIGS. 5 and 6 together illustrate a signal diagram 500 illustrating an example operation of the network 100 for implementing a distributed semantic communication scheme in accordance with some embodiments. For ease of illustration, the following provides some details for the operation of the distributed semantic communication scheme for the downlink pathway 114; that is, for communicating one or more semantic meanings of application data generated by the application server 106 for use by the user software application 112 of the UE 110. It will be appreciated that the following description similarly applies to operation of the distributed communication scheme for the uplink pathway 116; that is, for communicating one or more semantic meanings of application data generated by the user software application 112 for use by the application server 106.

Operation of the distributed semantic communication scheme for the downlink pathway 114 typically is initiated with a local application trigger 502 at the UE 110, which can include, for example, the start-up or other initiation of a software application 112 that will use one or more semantic meanings extracted from application data that is to be generated by the application server 106 to control one or more operations of the UE 110, such as through the initiation, control, modification, or other impact to the execution of a particular subroutine, library, call function, application programming interface (API), or the like at the UE 110. In response, at action 504 the UE neural network manager 214 determines present situational context data 162 for the UE 110 as it pertains to configuring the downlink pathway 114 and/or the uplink pathway 116. This present situational context data 164 can be represented at least in part based on a present iteration of the sensor data obtained from the sensor set 210, and which may represent, for example, present network channel conditions, such as available bandwidth or observed latency, UE-observed signal-to-noise ratio (SNR), signal-to-interference plus noise ratio (SINR), reference signal received power (RSRP), reference signal received quality (RSRQ), and the like. The present situational context data 162 further may represent a present situational context of the operating state of the UE 110 itself, such as available processing resources or processing resource utilization, available memory resources or memory resource utilization, present battery capacity, etc. The present situational context data 162 also may include data representing the relationship between the UE 110 and its physical environment, including pose data, position data, radar data, lidar data, and the like. Further, the present situational context can include an identification of the type of software application 112 that instigated the local application trigger 502 (e.g., video, image, audio, VR, XR, gaming, telepresence, etc.), as well as some of the requirements or other parameters of the software application 112 with respect to the semantic communication scheme, such as semantic QoS requirements or QoE requirements.

The UE 110 then wirelessly transmits a request 506 for instantiation of a semantic communication configuration to the BS 108, with this request 506 including or being associated with data representing the determined present situational context of the UE 110. In one embodiment, one or both of the request 506 or the data representing the present situational context of the UE 110 are transmitted to the BS 108 as part of a UE Capability Information radio resource control (RRC) message or a UE Assistance Information RRC message. For example, in one embodiment, the UE 110 transmits the request 506 to the BS 108 and, in response, the BS 108 replies with a UE Capability Enquiry RRC message to the UE 110. In response to the UE Capability Enquiry RRC message, the UE 110 determines the data representative of the present situational context and transmits this data to the BS 108 as a UE Capability Information RRC message. In other embodiments, the request 506 and the data representing the present situational context of the UE are transmitted together as a UE Capability Information RRC message. At action 508, the BS 108 in turn may determine its own present situational context, such as BS-observed network channel conditions, such as BS-observed bandwidth, latency, error rate, SNR, SINR, RSRP, and/or RSRQ. The BS present situational context further can include present resource availability or utilization at the BS 108, and the like.

As described in greater detail below with reference to FIG. 7, in implementations various combinations of parameter values for parameters of a UE situational context and/or a BS situational context may be identified and then a corresponding set of neural network architecture configurations for the network semantic encoder neural network 126 and UE semantic decoder neural network 130 (and network channel encoder neural network 134 and UE channel decoder neural network 138 when implemented) are jointly trained for each identified combination of parameter values to generate a corresponding candidate neural network pathway. For example, for a set of parameters for a UE situational context in which a particular type of semantic communication is specified (e.g., a type of semantic meaning extraction for a given type of input application data, such as a text synopsis of recorded audio or a text descriptor of one or more objects present in the content of an image or video), a semantic KPI or other semantic quality expectation for the semantic meaning communication is specified, a particular set of network channel conditions are specified, and a particular set of UE resource availabilities is specified, a candidate set including a corresponding candidate network semantic encoder neural network architecture configuration, a candidate UE semantic decoder neural network architecture configuration, and, when implemented, one or both of a candidate network channel encoder neural network architecture configuration or a candidate UE channel decoder neural network architecture configuration can be jointly trained for the downlink pathway 114 under simulated conditions that meet these specified parameters, so as to generate one candidate neural network pathway for the downlink pathway 114. For a different combination in which a different type of semantic meaning extraction is specified, a different semantic quality type or level is specified, a different network QoS expectation is specified, a different set of network channel conditions are specified, and/or a different set of UE resource availabilities is specified, a different candidate network semantic encoder neural network architecture configuration, candidate UE semantic decoder neural network architecture configuration, candidate network channel encoder neural network architecture configuration, and/or candidate UE channel decoder neural network architecture can be jointly trained for this different set of specified parameters to generate another candidate neural network pathway, and so forth. This same process may be applied for determining one or more jointly-trained candidate sets of neural network architecture configurations for the uplink pathway 116. Thus, as a result of different neural network training iterations for different combinations of situational context parameters (for the UE 110, the BS 108, and or the network channel connecting the two), the network 100 may generate sets of candidate jointly-trained neural network architectural configurations for the downlink pathway 114 and/or the uplink pathway 116.

The situational context parameters selected for use in joint training of a corresponding candidate set of neural network architectures can include any variety and combination of situational context parameters. For example, the selected situational context parameters can include hardware capabilities, indicating certain processing, memory, and/or storage capabilities, such as maximum instruction throughput, maximum memory access speed, current instruction throughput, current memory access speed, current utilization of a particular hardware resource, and the like. The selected situational context parameters also can include one or more network QoS or QoE requirements, such as QoS requirements pertaining to jitter, throughput, latency, data loss, and the like. Parameters pertaining to the present conditions of the network channel(s) connecting the UE 110 and the BS 108, such as the aforementioned observed bandwidth, latency, error rate, SNR, SINR, RSRP, and/or RSRQ, may be selected. The selected situational context parameters also can include one or more semantic QoS or QoE requirements, such as one or more semantic KPI requirements. Power and/or thermal parameters likewise may be considered. This may include, for example, whether the UE 110 is connected to a non-battery power source or to a battery power source, and if the latter, the amount of remaining battery power. Another example may be some parameter pertaining to the thermal state of the UE 110 overall or for one or more components of the UE 110, such as a current skin temperature and its relationship to a specified threshold, or a thermal state of one or more processing components of the UE 110 in view of one or more corresponding thresholds. The selected situational context parameters also may include parameters pertaining to the software application(s) 112 that will consume the semantic meaning(s) communicated by the downlink pathway 114, such as the type of semantic meaning(s) to be communicated and the type of application data from which the semantic meaning(s) are extracted, the manner in which the software application 112 will utilize the semantic meaning to control one or more operations of the UE 110, the prioritization of the software application 112, and the like. Still further, parameters pertaining to the relationship of the UE 110 to the physical environment, such as location and/or pose, the presence or absence of interferer objects, and the like, may be utilized as training parameters.

The candidate neural network architectural configurations determined through such joint training may be made available for implementation at the BS 108 and the UE 110 in any of a variety of ways. In some embodiments, the network 100 may utilize a centralized repository of these candidate neural network architectural configurations, such as at a component of the core network 102 or at the application server 106, and the BS 108 or UE 110 may access an identified neural network architectural configuration for implementation as a corresponding neural network by requesting the identified neural network architectural configuration using a corresponding index or other identifier or by being supplied the identified neural network architectural configuration as a result of selection of the identified neural network architectural configuration based on analysis of one or both of the present situational context of the UE 110 or the present situational context of the BS 108. In other implementations, a local cache of some or all of the trained sets of neural network architectural configurations may be stored at each of the BS 108 and the UE 110, and the BS 108 and UE 110 each may access a corresponding neural network architectural configuration for implementation from the corresponding local cache based on an index or other identifier associated with the corresponding neural network architectural configuration.

In some embodiments, the application server 106 operates to select the neural network architectural configurations to be implemented for the downlink pathway 114 and/or the uplink pathway 116. In such situations, the BS 108 forwards the request 506 to the application server 106, along with the data representing the present situational context of the UE 110 and/or the present situational context of the BS 108, as a neural network configuration request 510. In other embodiments, the BS 108 (or other network edge component) operates to select the neural network architectural configurations for the downlink pathway 114 and/or the uplink pathway 116. In either approach, at action 512 either the BS 108 or the application server 106 uses the present situational context of the UE 110 and/or the present situational context of the BS 108 to select suitable jointly-trained sets of semantic encoder/decoder neural network architecture configurations (and channel encoder/decoder neural network architecture configurations, when utilized) for implementation from the corresponding sets of candidate jointly-trained network architecture configurations, as well as to select a suitable neural network architecture configuration from a corresponding set of candidate neural network architecture configurations for implementation as the neural networks of the downlink pathway 114. The BS 108/application server 106 can make this selection algorithmically using the present situational contexts of the UE 110 and/or BS 108 as inputs, via a look-up table (LUT) or other similar selection structure using these same inputs, or the selection itself may utilize a trained neural network that takes the present situational context(s) of the UE 110 and/or BS 108 as inputs.

The selection of a particular candidate neural network pathway determines the neural network architectural configurations for the network semantic encoder neural network 126 and the UE semantic decoder neural network 130 of the downlink pathway 114 and, if implemented, the network channel encoder neural network 134 and the UE channel decoder neural network 138. Further, if the uplink pathway 116 also is implemented, this selection also may determine the neural network architectural configurations for the UE semantic encoder neural network 128 and the network semantic decoder neural network 132, and if implemented, the UE channel encoder neural network 136 and network channel decoder neural network 140 as well. Accordingly, at action 514 the component selecting the candidate neural network pathway sends an indication of the selected neural network architecture configurations to the BS 108 (if the BS 108 is not the component doing the selection) and to the UE 110, with the BS 108 receiving an indication of the neural network architecture configurations to implement for some or all of the neural networks 126, 134, 132, or 140 and the UE 110 receiving an indication of the neural network architecture configurations to implement for some or all of the neural networks 128, 130, 136, or 138. As noted above, these indications may include identifiers used to index into a local or global repository of such neural network architecture configurations, the actual weights, connections, and other parameters of the neural networks themselves, or a combination thereof—including a baseline neural network architecture and modifications of weight and biases of the baseline.

In response to receiving the indication (or in response to making the selection from the candidate neural network pathways), at action 516 the BS 108 implements the indicated neural network architectural configuration at the network semantic encoder neural network 126 and, if neural-network-based channel encoding is employed, at the network channel encoder neural network 134 using corresponding instances of, for example, the ML module 400 of FIG. 4. The same process may be employed for the network channel decoder neural network 140 and network semantic decoder neural network 132 for the uplink pathway 116. Likewise, at action 518 the UE 110 implements the indicated neural network architectural configurations at the UE semantic decoder neural network 130 and, if neural-network-based channel encoding is employed, at the UE channel decoder neural network 138 using corresponding instances of, for example, the ML module 400 of FIG. 4. The same process may be employed for the UE channel encoder neural network 136 and UE semantic encoder neural network 128 for the uplink pathway 116.

With the pathways 114 and/or 116 configured and initialized, the distributed semantic communication scheme is ready for extracting and communicating semantic meaning(s) from input application data. Accordingly, at action 520 the application server 106 generates application data 142 based on its configured operation and provides the application data 142 to the BS 108. As noted above, this application data can include any of a variety of types of data from which semantic meanings may be determined, such as video, imagery, audio, text, and the like. At action 522, the network semantic encoder neural network 126 of the BS 108 receives the input application data 142 as an input and processes this input according to its trained architectural configuration to generate the first output signal 146, which, in effect, is a semantic code representative of one or more semantic meanings extracted by the network semantic encoder neural network 126 from the application data 142 in accordance with its neural network configuration. As explained above, the one or more semantic meanings may reference any of a variety of semantic meanings that may be represented by the application data 142, depending on its type. For example, a semantic meaning may include a summary or synopsis of the textual, audio, and/or video content of the application data 142, confirmation of the presence or absence of one or more objects in the subject of the application data 142, simplified representation of the subject of the application data 142 (such as representing imagery of a cat in the application data 142 with a simplified logo or other symbolic imagery of a cat), and the like. In performing this process, the network semantic encoder neural network 126 may also receive and process other inputs that may inform the semantic meaning extraction process, such as an indication of a current semantic quality level requested or otherwise indicated by the software application 112, an indication of the current situational context of the BS 108, and the like.

In implementations in which neural-network-based channel encoding also is employed, at action 524 the BS 108 supplies the first output signal 146 as an input to the network channel encoder neural network 134, which also may concurrently receive other inputs, such as present situational context data 162 from the UE 110 and/or present situational context data 164 from the BS 108. The network channel encoder neural network 134 processes these inputs according to its neural network architectural configuration to generate the second output signal 150, which is, in effect, a channel-encoded representation of the first output signal 146. At action 526, the BS 108 transmits the second output signal 150 for receipt by the UE 110. In implementations in which neural-network-based channel encoding is not employed, then action 524 is omitted and the first output signal 146 is processed using conventional channel encoding techniques and the result is transmitted as second output signal 150.

At the UE 110, the second output signal 150 is received and processed. In embodiments in which neural-network-based channel decoding is employed, this processing includes, at action 528, providing the second output signal 150 as an input to the UE channel decoder neural network 138. One or more other inputs, such as an instance of the present situational context data 162, also may be provided concurrently. The UE channel decoder neural network 138 processes these inputs according to its trained architectural configuration to generate the third output signal 154, which represents, in effect, a channel-decoded representation of the first output signal 146. In implementations in which neural-network-based channel decoding is not employed, then action 528 is omitted and the second output signal 150 is provided as the third output signal 154.

As noted above, in some implementations the operation of the neural-network-based semantic encoding or decoding process may be based in part on the current situational context of the component performing the process. As such, at action 530 the UE 110 may determine or otherwise obtain the local situational context of the UE 110. This can include, for example, a current instance of present situational context data 162 of the UE 110, such as memory-related capabilities, processing-related capabilities, power-related capabilities, network-related capabilities, semantic quality requirements or capabilities, and the like.

At block 532, the third output signal 154 and a representation of the local situational context of the UE 110 (if so determined at action 530) are provided as inputs to the UE semantic decoder neural network 130, which processes these inputs according to its neural network architectural configuration to generate the fourth output signal 158 that represents, in effect, a semantic decoding of the first output signal 146 so as to obtain a representation of the one or more semantic meanings determined by the network semantic encoder neural network 126 for the application data 142 and represented in the first output signal 146. At block 534, the software application 112 performs (or initiates the performance of) one or more operations at the UE 110 based on these one or more semantic meanings. For example, if a recovered semantic meaning is a text summary of an audio file (as an embodiment of the application data 142), then the one or more operations can include, for example, display of the text summary, output of text-to-voice audio conversion of the text summary, processing of the text summary to add a calendar event to a calendar application for an event identified in the text summary, and the like. As another example, if the semantic meaning is the identification of a subject of the application data 142, or confirmation of the presence or absence of a specified subject in the application data 142, then one or more operations can be triggered based on identification of this object or identification of the presence or absence of this object. In some embodiments, the one or more operations can include controlling the software application to present the one or more semantic meanings, such as by displaying a representation of a semantic meaning in graphical or textual form, by outputting audio representative of a semantic meaning, and the like.

Referring again to action 530, as explained above, the local situational context of the UE 110 may be utilized by may be utilized by the network 100, such as by the network semantic encoder neural network 126 in extracting and encoding semantic meanings for a subsequent instance of application data or by the network channel encoder neural network 134 for encoding the next instance of a first output signal from the network semantic encoder neural network 126, by the network channel decoder neural network 140 in decoding a signal received from the UE channel encoder neural network 136, and/or by the network semantic decoder neural network 132 in decoding and extracting semantic meanings from a signal generated by the UE semantic encoder neural network 128. Further, the application server 106 may utilize the current local situational context of the UE 110 in generating the next instance of the application data 142. As such, FIG. 6 depicts a signal diagram 600 that illustrates an example of this use of local situation context of the UE 110 as feedback in accordance with implementations.

With the obtainment of the present instance of the local situational context of the UE 110 at action 530 (FIG. 5), the UE 110 also can feed this context data back to the network via the uplink pathway 116. Accordingly, at action 602 the local situational context data 162 is input to the UE channel encoder neural network 136, which processes the local situational context data according to its trained architecture configuration to generate an instance of the second output signal 152, which, in effect, is an encoded representation of the input local situational context data. At action 604 the UE 110 wirelessly transmits the second output signal 152 to the BS 108. At action 606, the second output signal 152 is provided as an input to the network channel decoder neural network 140, which processes this input according to its trained architectural configuration to generate a corresponding instance of the context signal, which, in effect, represents a decoded representation of the effectively encoded representation of the local situational context data obtained by the UE 110. At action 608, the context signal is employed by one or more components of the BS 108 or the application server 106, such as by providing the context signal as an input to the network channel encoder neural network 134 and/or the network semantic encoder neural network 126.

As explained above, in some embodiments the distributed semantic communication scheme of the network 100 utilizes a select one of a plurality of candidate neural network pathways for one or both of the downlink pathway 114 or the uplink pathway 116. In this implementation, each candidate neural network pathway includes a corresponding neural network architecture configuration for each of the semantic encoder neural network and semantic decoder neural network of the pathway, and if employed, one or both of a channel encoder neural network or a channel decoder neural network for the pathway, the combination of which has been jointly trained in view of a corresponding set of situational context parameters representing specific situational context parameters for the UE 110 and/or the BS 108, such as power parameters, resource availability parameters, thermal parameters, software type parameters, network quality parameters, semantic quality parameters, and the like.

FIG. 7 illustrates an example method 700 for such joint training of candidate neural network architectural configurations for the downlink pathway 114 in accordance with implementations. Although described with reference to downlink pathway 114, the same or similar process may be employed for joint training of the neural networks of the uplink pathway 116 using the guidelines provided herein. Moreover, for the following it is assumed that the set of candidate neural networks being jointly trained includes candidate neural networks for both a channel encoder neural network and a channel decoder neural network for the pathway in addition to the semantic encoder neural network and semantic decoder neural network for the pathway.

An iteration of method 700 starts with a training system identifying the situational context parameters to be associated with the corresponding candidate neural network pathway to be jointly trained for this iteration at block 702. To illustrate, for this iteration, the corresponding parameter set could include: one or more semantic quality requirements, such as an indication of a minimum semantic KPI, a certain range of processing resource utilization at the UE 110 combined with a certain QoS/QoE specification, a certain battery remaining range for the UE 110, a certain thermal range for the UE 110, a range of network channel conditions observed by the UE 110, a range of network channel conditions observed by the BS 108, and a range of UEs presently being served by the BS 108. At block 704, the training system initializes training instances of each of the network semantic encoder neural network 126, the UE semantic decoder neural network 130, the network channel encoder neural network 134, and the UE channel decoder neural network 138 based on the situational context parameters identified at block 702.

At block 706, the training system obtains a batch of training data sets that reflect the corresponding situational context parameter set, such as a batch of training data sets including a plurality of training data instances, each training data instance including known input prompt information and corresponding known and suitable resulting generated content. At block 708, the training system processes each training data set in the chain of neural networks of the downlink pathway 114. This can include inputting the known input application data from the training data set into the training instance of the semantic encoder neural network 126, providing the resulting output signal as an input to a training instance of the network channel encoder neural network 134, transmitting the resulting output from the network channel encoder neural network 134 over a network channel that has constraints representing the channel characteristic parameters identified at block 702 (or simulating the transmission of the resulting output over an emulated version of such a network channel having similar constraints), and processing the received result at the training instance of the channel decoder neural network 138 at an actual or simulated UE having constraints consistent with the UE situational context parameters as those identified at block 702 (e.g., same available processing resources as specified, same remaining battery level as specified, etc.). The resulting output is then processed at the training instance of the semantic decoder neural network 130 at an actual or simulated UE having the same identified UE local situational context parameters, which results in a generated output.

After all training data sets of the batch have been processed in this matter, at block 710 the training system determines the performance of the candidate neural network pathway in processing the batch of training data sets. For example, this can include calculating a joint loss function using performance metrics associated with one or more of the generated output content for each training data set (e.g., how closely does the generated output content reflect the expected output content), performance metrics for the real or simulated operation of each of the neural networks (e.g., how closely does the operation meet a specified QoS/QoE goal and/or semantic quality goal, maintain an acceptable battery drain rate, utilize processing resources within an acceptable range), etc. At block 712, the training system determines whether this analyzed performance indicates that the candidate neural network pathway has been sufficiently trained. For example, whether the one or more joint loss functions indicate errors within corresponding acceptable ranges. If the training system decides that the candidate neural network pathway has been sufficiently trained, at block 714 the resulting trained architecture configuration of each neural network in the neural network pathway is extracted and stored for subsequent use as neural network architecture configurations for the neural networks of the corresponding candidate neural network pathway. This can include, for each neural network being trained, the extraction and storage of, for example, parameters that specify a fully connected layer neural network architecture, a convolutional layer neural network architecture, a recurrent neural network layer, a number of connected hidden neural network layers, an input layer architecture, an output layer architecture, a number of nodes utilized by the neural network, coefficients (e.g., weights and biases) utilized by the neural network, kernel parameters, a number of filters utilized by the neural network, strides/pooling configurations utilized by the neural network, an activation function of each neural network layer, interconnections between neural network layers, neural network layers to skip, and so forth.

Otherwise, if the training system determines that the candidate neural network pathway has not been sufficiently trained at block 712, then at block 716 the training system updates the architectural configurations for the neural networks in the candidate neural network pathway being trained by, for example, updating the weights and other parameters of the training instances of the neural networks using gradient back-propagation based techniques based on the aforementioned loss function(s). After updating, the method 700 returns to block 706 in which another batch of training data sets is obtained and another iteration of the training process is performed with this next batch of training data.

While the above describes a process in which all training instances of four neural networks 126, 130, 134, and 138 of the downlink pathway 114 are jointly trained together, in other instances, different joint trainings may be employed. For example, in some instances, the training instances of the network semantic encoder neural network 126 and the UE semantic decoder neural network 130 may be jointly trained, while training instances of the network channel encoder neural network 134 and the UE channel decoder neural network 138 are separately jointly trained, thereby allowing the semantic encoder/decoder neural networks to be employed separately without also requiring use of the channel encoder/decoder neural networks. Likewise, to facilitate instances in which the BS 108 may not employ the network channel encoder neural network 134 or the UE 110 may not employ the UE channel decoder neural network 138, different candidate sets can be trained for different combinations of the neural networks, such as training of one or more candidate sets for an instance of the downlink pathway 114 in which the semantic encoder neural network 126, semantic decoder neural network 130, and network channel encoder neural network 134 are present but the UE channel decoder neural network 138 is absent, and separately training one or more candidate sets for a different instance of the downlink pathway 114 in which the semantic encoder neural network 126, semantic decoder neural network 130, and UE channel decoder neural network 130 are present but the network channel encoder neural network 134 is absent. This allows the uplink pathway configuration process represented by, for example, actions 502-518 of FIG. 5 to accommodate a variety of implementation instances in which the channel encoder/decoder neural networks may be present or absent depending on the particular implementation.

In some embodiments, certain aspects of the techniques described above may be implemented by one or more processors of a processing system executing software. The software includes one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM), or other non-volatile memory device or devices, and the like. The executable instructions stored on the non-transitory computer-readable storage medium may be in source code, assembly language code, object code, or another instruction format that is interpreted or otherwise executable by one or more processors.

A computer-readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A computer-implemented method in a first device, comprising:
transmitting situational context information to a network, the situational context information representing at least one of a present situational context of the first device or a semantic requirement of a software application of the first device;
responsive to transmitting the situational context information, receiving from the network, an indication of a first neural network;
implementing the first neural network at the first device;
receiving, from a second device in the network, a first signal representative of a semantic code, the semantic code representing at least one semantic meaning of application data;
processing the first signal by at least the first neural network of the first device to generate a representation of the at least one semantic meaning; and
controlling an operation of the software application executing at the first device based on the at least one semantic meaning.

2. The method of claim 1, wherein processing the first signal further comprises:
processing the first signal at a second neural network of the first device to generate a second signal that is a channel decoded representation of the first signal; and
processing the second signal at the first neural network to generate the representation of the at least one semantic meaning.

3. The method of claim 2, wherein the first neural network is jointly trained with the second neural network.

4. The method of claim 2, wherein the first neural network and the second neural network are jointly trained with at least a third neural network implemented at the second device.

5. The method of claim 2, wherein processing the first signal at the second neural network further comprises: processing sensor data from one or more sensors of the first device at the second neural network concurrent with processing the first signal at the second neural network.

6. The method of claim 1, wherein the situational context information includes at least one of:
present capabilities of the first device;
an application type of the software application;
a semantic communication capability of the software application;
a present location of the first device;
a network condition of the first device;
a processing bandwidth of the first device;
a memory bandwidth of the first device;
a power status of the first device; or
a network condition of a network channel between the first device and the second device.

7. The method of claim 1, wherein the semantic requirement comprises at least one of: a semantic quantization level; a perceptional evaluation of speech quality (PESQ) score requirement; an image similarity metric; or a Fifth Generation quality of service identifier (5QI) requirement.

8. The method of claim 1, wherein the indication of the first neural network comprises at least one of:
an identifier of one of a plurality of candidate neural networks accessible by the first device; or
data representing a neural network architectural configuration of the first neural network.

9. The method of claim 1, wherein the first signal is an output of processing of the application data by a third neural network at the second device that is connected to the first device via a network channel, the third neural network being jointly trained with the first neural network.

10. The method of claim 1, wherein controlling the operation of the software application includes controlling the software application to present the at least one semantic meaning to a user of the first device.

11. The method of claim 1, wherein at least one of:
the application data is an image and the at least one semantic meaning is an identifier of a subject represented in the image;
the application data is a video and the at least one semantic meaning is a synopsis or summary of content of the video;
the application data is audio data and the at least one semantic meaning is a synopsis or summary of a content of the audio data; or
the application data is text and the at least one semantic meaning is a synopsis or summary of a topic of the text.

12. A computer-implemented method in a second device in a network, comprising:
receiving, from a first device, situational context information representing at least one of a present situational context of the first device or a semantic requirement of a software application of the first device;
transmitting an indication of a first neural network to the first device responsive to the situational context information;
processing application data by at least a third neural network of the second device to generate a first signal representing a semantic code, the semantic code representing at least one semantic meaning of the application data; and
transmitting the first signal for receipt by the second device.

13. The method of claim 12, wherein processing the application data further comprises:
selecting the third neural network for use at the second device responsive to the situational context information;
processing the application data at a third neural network to generate a third signal; and
processing the third signal at a fourth neural network of the second device to generate the first signal, the first signal being a channel encoded representation of the third signal.

14. The method of claim 13, wherein the first neural network is jointly trained with the third neural network and the fourth neural network.

15. The method of claim 13, wherein processing the application data further based on processing sensor data from one or more sensors of the second device at the third neural network.

16. A first device comprising:
a network interface;
at least one processor coupled to the network interface; and
a non-transitory computer-readable medium storing a set of instructions, the set of instructions configured to manipulate one or both of the at least one processor or the network interface to:
transmit situational context information to a network, the situational context information representing at least one of a present situational context of the first device or a semantic requirement of a software application of the first device;
responsive to transmitting the situational context information, receive from the network, an indication of a first neural network;
implement the first neural network at the first device;
receive, from a second device in the network, a first signal representative of a semantic code, the semantic code representing at least one semantic meaning of application data;
process the first signal by at least the first neural network of the first device to generate a representation of the at least one semantic meaning; and
control an operation of the software application executing at the first device based on the at least one semantic meaning.

17. A method at a network comprising:
configuring a first device to implement a first neural network and a second neural network, and a second device to use a third neural network and a fourth neural network based on one or both of a present situational context of the first device or semantic requirement of a software application of the first device, wherein the first neural network has been jointly trained with at least the fourth neural network;
generating, at an application server, application data;
processing the application data at the third neural network to generate a third signal, the third signal representing semantic code representative of at least one semantic meaning of the application data;
processing the third signal at the fourth neural network to generate a first signal, the first signal being a channel encoded representation of the third signal;
transmitting the first signal from the second device to the first device;
processing the first signal at the second neural network to generate a second signal, the second signal being a channel decoded representation of the first signal;
processing the second signal at the first neural network to generate an output, the output representing the at least one semantic meaning; and
processing the output at the first device to control at least one operation of the first device.

18. The method of claim 17, further comprising:
processing the first signal at a second neural network of the first device to generate a second signal that is a channel decoded representation of the first signal; and
processing the second signal at the first neural network to generate the representation of the at least one semantic meaning.

19. The method of claim 18, wherein generating the representation is further based on processing sensor data from one or more sensors of the first device at the second neural network concurrent with processing the first signal at the second neural network.

20. A second device comprising:
a network interface;
at least one processor coupled to the network interface; and
a non-transitory computer-readable medium storing a set of instructions, the set of instructions configured to manipulate one or both of the at least one processor or the network interface to:
receive, from a first device of the network, situational context information representing at least one of a present situational context of the first device or a semantic requirement of a software application of the first device;
transmit an indication of a first neural network to the first device responsive to the situational context information;
process application data by at least a third neural network of the second device to generate a first signal representing a semantic code, the semantic code representing at least one semantic meaning of the application data; and
transmit the first signal for receipt by the first device.

21. The second device of claim 20, wherein the second device is to process the application data further by:
selecting a third neural network for use at the second device responsive to the situational context information;
processing the application data at the third neural network to generate a second signal; and
processing the second signal at a fourth neural network of the second device to generate the first signal, the first signal being a channel encoded representation of the second signal.
